(19) United States
(12) Patent Application Publication
(10) Pub. No.: US 2024/0161008 A1
(43) Pub. Date: May 16, 2024

(54) RANKING-BASED TRAINING OF CLASSIFICATION MODEL FOR USE WITH CRITICAL RARE CASES

(71) Applicant: ROYAL BANK OF CANADA, Toronto (CA)

(72) Inventors: Kiarash Mohammadi, Montreal (CA); He Zhao, Richmond Hill (CA); Mengyao Zhai, Vancouver (CA); Frederick Tung, North Vancouver (CA)

(21) Appl. No.: 18/382,238

(22) Filed: Oct. 20, 2023

Related U.S. Application Data
(60) Provisional application No. 63/424,589, filed on Nov. 11, 2022.

(51) Int. Cl. G06N 20/00

(52) U.S. Cl. CPC G06N 20/00

(57) ABSTRACT

Binary classification models can be trained to classify data as being in one of two classes. Membership in a class may be imbalanced so that there are more members in one class than the other. Additionally, one of the classes may have a higher importance than the other, yet appear much less frequently. It is possible to train the binary classification model using a base loss function and a regularization function based on a ranking of training results in order to reduce the false positives at a high true positive rate.

### RELATED APPLICATIONS

The current application claims priority to U.S. Provisional Application No. 63/424,589 filed Nov. 11, 2022, the entire contents of which are incorporated herein by reference for all purposes.

### TECHNICAL FIELD

The current disclosure relates to training classification models and in particular to classification models for use with data having rare cases of critical importance.

### BACKGROUND

The cost of error is often asymmetric in real-world systems that involve rare classes or events. For example, in medical imaging, incorrectly diagnosing a tumor as benign, which would be a false negative, could lead to cancer being detected later at a more advanced stage, when survival rates are much worse. This would be a higher cost of error than incorrectly diagnosing a benign tumour as potentially cancerous, which would be a false positive. These rare positive cases can be considered critical to identify given the cost of misidentifying a positive case. Trained classification models used in such scenarios may be operated at a high true positive rates, even though this may require tolerating high false positive rates. High false positives can undermine user confidence in the system and responding to them can incur other costs, such as additional imaging tests to further investigate the false positives.

An additional, alternative and/or improved classification is desirable for use in scenarios with critical rare cases.

### BRIEF DESCRIPTION OF THE DRAWINGS

Further features and advantages of the present disclosure will become apparent from the following detailed description, taken in combination with the appended drawings, in which:

FIGS. 1A and 1B depict use of a binary classifier;

FIG. 2 depicts training options of a binary classifier;

FIG. 3 depicts ranked-based training of a binary classifier;

FIG. 4 depicts further ranked-based training of a binary classifier;

FIG. 5 depicts a system for training and using binary classifier;

FIG. 6 depicts a method of training a binary classifier;

FIG. 7 depicts test results of the training method;

FIG. 8 depicts graphs of false positive rates vs. true positive rates for different methods; and

FIG. 9 depicts noise ratio graphs for FPR@ different TPR.

### DETAILED DESCRIPTION

In accordance with the present disclosure there is provided A method of training a binary classifier applying a binary classification model to a training set to generate a classification score for each member of the set, the training set including true classification labels for each member; ranking the members of the training set based on the classification scores; and adjusting weights of the binary classification model using a loss function comprising: a base objective loss component based on classification scores of the training set; and a regularization loss component based on the ranking of members of the training set with a positive true classification label.

In a further embodiment of the method, ranking the members is given by: r=rk([f_{θ}(x₁), f_{θ}(x₂), . . . , f_{θ}(x_{B})], where: rk(a)=arg min a·π, πΠₙ and where Πₙ is a set that contains all the permutations of {1, 2, . . . , n}. The method of claim 1, wherein the regularization loss component is given by:

$${ℓ}_{reg} ( {f}_{θ} ( x ) , y ) = \frac{1}{\vert P \vert} {\sum }_{i = 1}^{B} {r}_{i}^{2} \cdot 1 [ {y}_{i} = 1 ] ,$$

where 1[] is the indicator function.

In a further embodiment of the method, the base objective function comprises one or more of: classic binary cross-entropy (BCE); symmetric margin loss (S-ML); symmetric focal loss (S-FL); asymmetric margin loss (A-ML); asymmetric focal loss (A-FL); cost-weighted BCE (WBCE); class-balanced BCE (CB-BCE); and label distribution aware margin (LDAM).

In a further embodiment of the method, the loss function is given by: [symbol] (f_{θ}(x),y)= [symbol] _{base}(f_{θ}(x),y)+λ [symbol] _{reg}(f_{θ}(x),y), where [symbol] _{base} is the base objective loss component; [symbol] _{reg} is the ranked-based regularization component; and is λ balancing hyperparameter.

In a further embodiment of the method, the training set comprises: a plurality of batch training samples; and a plurality of positive class samples stored in a positive class buffer.

In a further embodiment of the method, positive class samples from the batch training samples are used to updated the positive class buffer.

In a further embodiment of the method, the positive class buffer is updated according to one or more of: a first in first out policy; and a deMax policy.

In a further embodiment of the method, the method further comprises deploying the trained classification model to one or more computing systems.

In a further embodiment of the method, the method further comprises: receiving an unknown sample of data; and classifying the unknown sample as either being in the positive class or the negative class using the deployed trained classifier.

In accordance with the present disclosure there is further provided a non-transitory computer readable medium having stored thereon instruction which when executed configure a computing device to perform a method according to any of the methods described above.

In accordance with the present disclosure there is further provided a computing system comprising: a processor for executing instructions; and a memory storing instruction which when executed by the processor configure the computing device to perform a method according to any of the methods described above.

In many real-world imbalanced learning settings, the critical class is rare and the cost of missing it, a false negative, is asymmetrically high. For example, tumors are rare and a false negative diagnosis could have severe consequences on treatment outcomes. a further example, fraudulent banking transactions are rare and an undetected occurrence could result in significant losses or legal penalties. Training a classifier in such scenarios is difficult, not only because one class is rare compared to the other, but also because the cost of missing one of the rare cases is much greater than the cost of misidentifying the common case. In such situations with a critical rare class, classification systems are often operated at a high true positive rate, which may require tolerating high false positives. While conventional training methods of classifiers treat false positives and false negatives equally, as described further below, a training method can account for the challenge of minimizing false positives for systems that need to operate at a high true positive rate. The training uses a ranking-based regularization approach that is easy to implement, and is shown further below empirically that it not only effectively reduces false positives at a high true positive rate, but also complements conventional imbalanced learning losses.

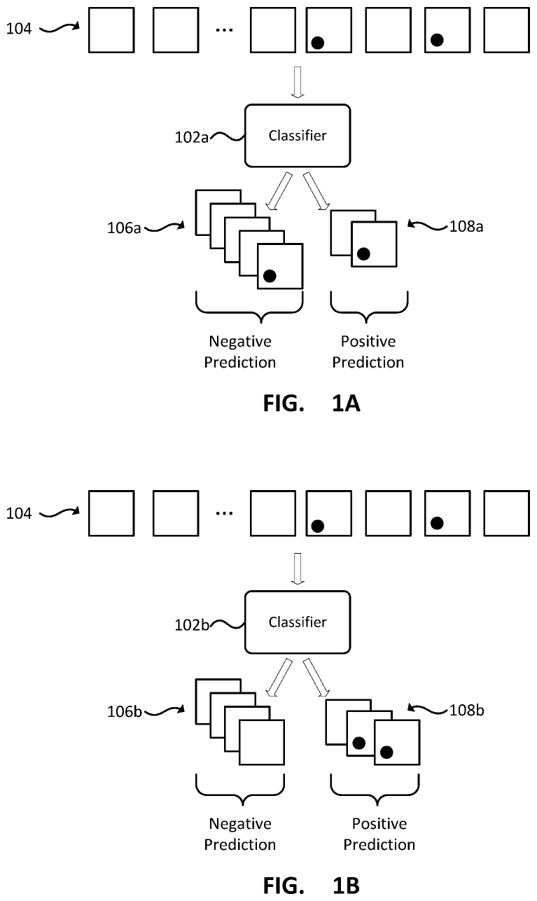

FIG. 1A depict use of a classier. The trained classifier 102a can take as input one or more pieces of data 104. The data may take many different forms, such as data on financial transactions, medical data, medical images, traffic data, traffic/autonomous driving images, phone call data, social network data, or other type of data that can be processed by a machine learning model and classified into one of two possible categories. As depicted, on one or more of the pieces of data 104 are associated with a positive class, depicted as the data members with the black circle. The classifier 102a provides an output for each member of the input data 104 that predicts whether the data member is a member of the negative case 106a, or the positive case 108a. As depicted, the classifier 102 incorrectly predicts one member as being in the positive class that is in fact a member of the negative class and also misidentifies or incorrectly predict one member as being in the negative class that is in fact a member of the positive class.

While it is desirable for the classifier to not make any mistakes, the misclassification of the actual positive member as being in the negative class is more problematic than misidentifying the negative member in the positive class.

FIG. 1B depict use of a further classifier. The classifier 102b is similar to that described above; however has been trained according to the current disclosure. As depicted, the classifier 102b still misidentifies a negative member as being in the positive class 108b instead of the negative class 106b; however, it correctly predicts both positive members as being in the positive class.

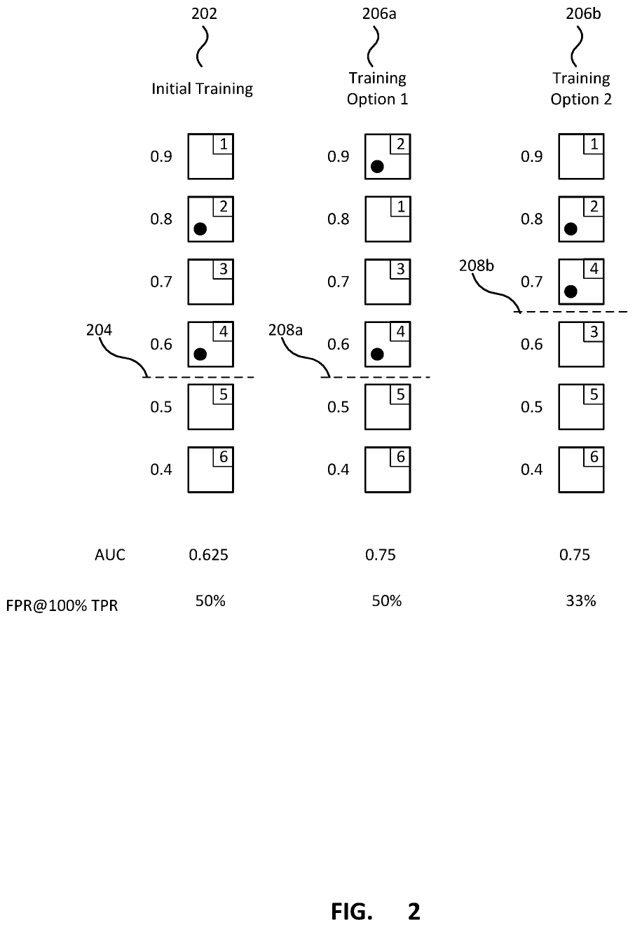

FIG. 2 depicts training of a classifier using a ranked based approach. When training a classifier, the partially trained classifier is applied to training data and the result compared using a loss function in order to minimize the error. FIG. 2 depicts an initial training result 202 of applying the classifier to training data. The classifier provides a score for each member of the training data. A threshold value, depicted as dashed line 204, can be used to identify class membership. For example, scores above the threshold 204 may be used to predict membership in the positive class, while scores below the threshold 204 may be used to predict membership in the negative class.

FIG. 2 depict to options for the outcome of further training of the classier. In the first training option 206a, the weightings of the classifier are adjusted so that one of the positive examples, data member 2, has a score of 0.9, ranking it higher than data member 1. The lowest positive member 4 has a score of 0.6. The threshold 208a may be set as the score of the lowest positive member, namely 0.6.

The second training option 206b has weightings of the classifier so that one of the positive members, data member 4, is scored at 0.7. In the second training option, the lowest possible data member is scored a 0.7 and so the positive class threshold 208b is higher.

FIG. 2 also depict characteristics of the classifier results. The initial training results have an area under the receiver operating characteristic (ROC) curve (AUC) value of 0.625. Both training options have an improved AUC of 0.75 and as such both training options may be considered equally good using only this measure. However, both the initial training and the first training option have a false positive rate (FPR) of 50% at a 100% true positive rate (TPR), that is with a positive class threshold as depicted in FIG. 2. Accordingly, the FPR of training option 1 is not an improvement. Training option 2 has a lower false positive rate of 33% at a 100% true positive rate (TPR). Accordingly, training option 2 is desirable as it provides improved AUC and FPR.

A method of training a classifier that tends to result in training option 2 is described further below. The training preferentially reduces false positives at a high TPR when presented with different options that equally improve the AUC. In the example depicted in FIG. 2, the regularizer method of training prefers option 2 since it leads to fewer false positives at a 100% detection rate.

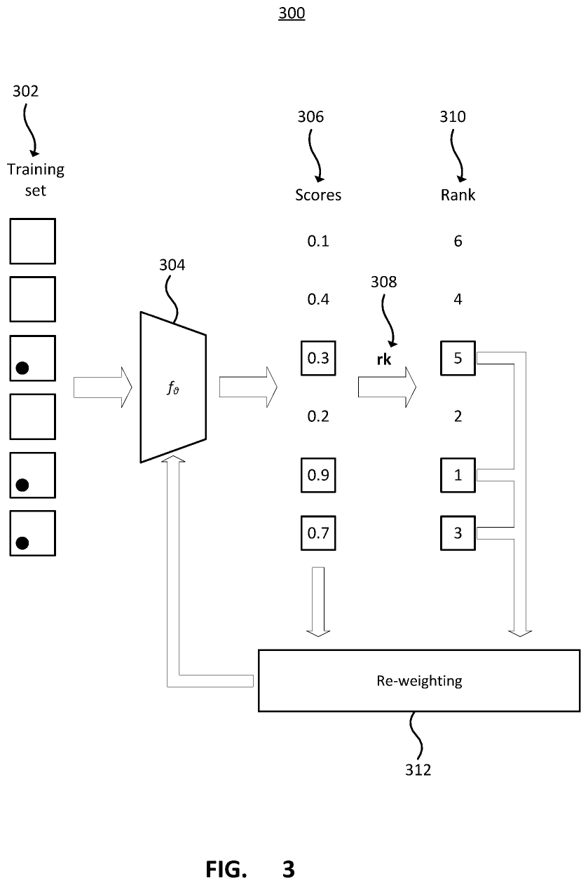

FIG. 3 depicts ranked-based training of a binary classifier. The regularizer training method uses a ranked-based process to address the challenge of minimizing false positives for systems that need to operate at a high true positive rate. While there is a rich body of work in imbalanced learning, conventional methods treat false positives and false negatives equally. The training re-calculates weightings of the classifier based on the output scores and a ranking of the positive members of the training data.

As depicted in FIG. 3, a training set 302 of a plurality of elements comprising labelled examples of both negative and positive class members are provided to a partially trained classifier model 304 that outputs a score 306 for each of the members of the training set. The positive examples of the training set are depicted with a small black circle. The corresponding scores of the positive examples are depicted within a square. A ranking function 308 can be applied to the scores in order determine a ranking, or ordering, 310 of the output. As will be appreciated from FIG. 2, it is desirable to have all of the positive class members ranked highest. A re-weighting 312 of the classification model 304 can be determined based on the scores 306 and on the ranking 310. The re-weighting of the proposed ranking-based regularizer is tailored asymmetrically to the high true positive rate (TPR) setting, prioritizing the minimization of false positives at a high TPR.

The training process addresses the problem of binary classification over a highly imbalanced dataset D={(x₁,y₁), (x₂,y₂), . . . , (xₙ,yₙ), yᵢ∈{0,1}}, where the critical data samples, namely the positive class, labelled 1 appear much less frequently than the non-critical data samples, or the negative class, labelled 0. It will be appreciated that the critical class does not need to be the positive class and the label associated with different classes can be any appropriate label. For example, medical images with cancerous tumors may be critical positives, while images with benign tumors or no tumors may be negatives. It is assumed that the cost of missing the positive class, a false negative, carries a disproportionately high cost, and that the system is required to operate at a high true positive rate (TPR).

A goal is to produce a general method for inducing a deep neural network (DNN) classifier f_{θ}: [symbol] ^{d}→ [symbol] to treat false positives and false negatives asymetrically, and in particular to prioritize the reduction of false positives at a high TPR. To be as general as possible, the method makes minimal assumptions on the architecture and optimization details of f_{θ} of the classifier.

A ranking-based regularizer is described that fulfills the above desiderata. The approach adds a regularization term to the usual DNN training objective, making the ranking based solution complementary to a wide range of base objective loss functions, from conventional binary cross entropy to more sophisticated imbalanced losses such as asymmetric focal loss. In other words, the DNN training loss objective is modified to include a ranking based component in addition to the base loss function based on the scores. The training loss objective function is modified to be:

[symbol]

(f_{θ}(x),y)= [symbol] _{base}(f_{θ}(x),y)+λ [symbol] _{reg}(f_{θ}(x),y) (1)

where [symbol] _{base} is the base objective function, [symbol] _{reg} is the new ranked-based regularization term, and is a balancing hyperparameter.

The rank can be determined by a ranking function denoted by rk. The ranking function takes a vector of real values a and outputs the rank of each element in the sorted vector. In other words, the ith element in rk(a) is given by:

rk(a)ᵢ=1+|{j:aⱼ>aᵢ}| (2)

Then, a regularization term was devised that is computed as the normalized sum over the squared rank values of the positive samples:

$$r = rk ( [ {f}_{θ} ( {x}_{1} ) , {f}_{θ} ( {x}_{2} ) , … , {f}_{θ} ( {x}_{B} ) ] \qquad ( 3 )$$

$${ℓ}_{reg} ( {f}_{θ} ( x ) , y ) = \frac{1}{\vert P \vert} {\sum }_{i = 1}^{B} {r}_{i}^{2} \cdot II [ {y}_{i} = 1 ] \qquad ( 4 )$$

where [symbol] [] fill is the indicator function and

$$\frac{1}{\vert P \vert} {\sum }_{i = 1}^{B} \cdot II [ {y}_{i} = 1 ]$$

is the number of positive samples in the batch of B samples. Since positive samples may be severely under-represented in the dataset, each batch of training data should include at least one example of the positive class. The rank values r can also be normalized to be between 0 and 1.

To see how this regularization term prioritizes the reduction of false positives at high TPR, consider the example depicted in FIG. 2. Suppose that the classifier f_{θ} currently produces the sorted ordering shown in the left column. The critical rare positives are represented by the squares with a black circle and the negatives are represented by the empty squares. The positive examples induce the second and fourth highest classification scores (higher is better for positives). To achieve a high TPR of 100% on these two positives, it would be necessary to accept at least two false positives, obtaining an FPR of 50%. Now, suppose that in the next training iteration, the optimizer has two options, shown in the middle and right columns, that would equally improve the training base objective; here, it is illustrated with the area under the ROC curve (AUC), a common retrieval-based objective. While equally preferable by the training objective, the right column is better aligned with the goal of reducing false positives at high TPR: with a suitable threshold, it is possible to obtain an FPR of 33% at a TPR of 100%. On the other hand, the middle column can at best achieve an FPR of 50% at a TPR of 100%.

The proposed regularization term distinguishes between the middle and right columns, and assigns a higher loss to the middle column. In the middle column, the positive elements have the first and fourth highest classification scores, producing a regularization loss of 1²+4²=17. It is noted that the normalization terms are omitted here for simplicity of presentation. In the right column, the positive elements have the second and third highest classification scores, producing a regularization loss of 2²+3²=13. The proposed regularization therefore favors the right column, as desired. Note that if the ranks are used directly instead of squaring, the regularization loss would be 5 in both cases.

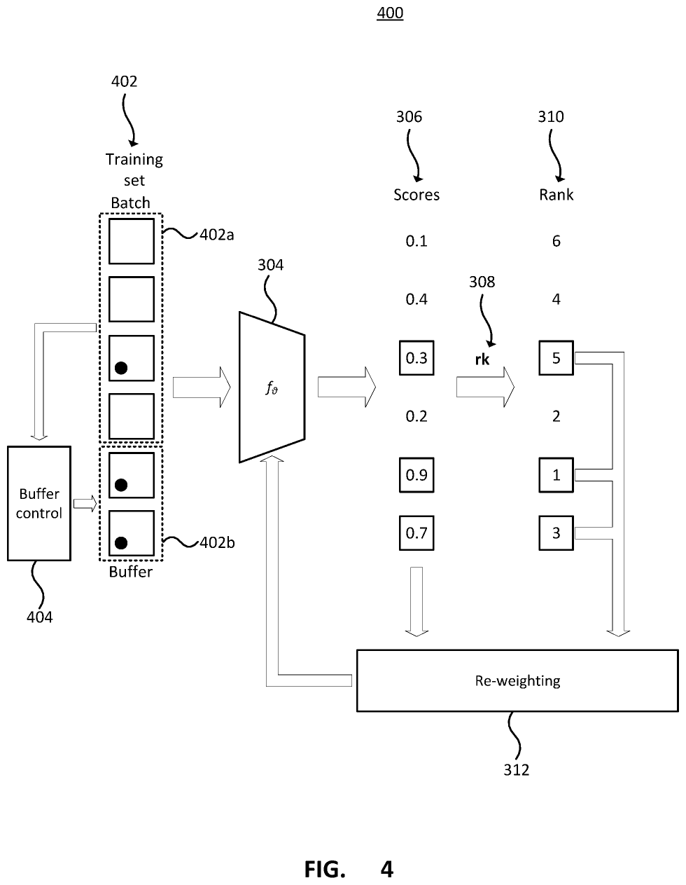

FIG. 4 depicts further ranked-based training of a binary classifier. The training depicted in FIG. 4 is similar to that described above with reference to FIG. 3 and only the differences will be described further. Since the positive cases are rare, not all batches of training data may have a positive example, or enough positive examples for training the classifier. Accordingly, the training may provide the training set 402 as a union between the batch samples 402a and one or more positive samples stored in a buffer 402b. The training may use a buffer replacement strategy 404 to replace elements in the buffer with positive members from the batch data 402a.

During training, the buffer, which may be provided in memory, of positive samples can be maintained to enable the regularization term to be computed per batch even in datasets with severe imbalance ratios, as a batch of training data may contain few, or no positive samples. At the start of training, positive samples are accumulated in the buffer up to a fixed maximum capacity. Afterwards, as batches are processed, new positive samples replace the samples in the buffer according to a replacement strategy. The strategy could be a simple first-in first-out (FIFO) buffer or may use a more complex replacement strategy. For example, the buffer may replace the sample for which the model is the most certain, i.e., the buffered samples with the maximum A responses. This replacement strategy keeps the hard positives in the buffer for use in further training of the classifier and removes positives for which the classifier is already confident. Alternatively, the buffer control 404 may replace the hard samples as it may not be possible, or at least hard or slow, for the classifier to ‘learn’ the hard cases.

Rank-based objectives often arise in computer vision however they are challenging to optimize due to the non-differentiability of the ranking function. The ranking function described herein is piece-wise constant, i.e., perturbing the input would most likely not change the output. Thus, it is difficult obtain informative gradients (i.e., gradients are zero almost everywhere). The optimization approach of described in “Optimizing rank-based metrics with blackbox differentiation” of Rolínek et al., in IEEE/CVF Conference on Computer Vision and Pattern Recognition, 2020, incorporated herein by reference in its entirety for all purposes, which frames the ranking function as a combinatorial solver and relies on an way of back-propagating through blackbox combinatorial solvers as described in “Differentiation of blackbox combinatorial solvers” of Vlastelica et al., in International Conference on Learning Representations, 2020, which is incorporated herein by reference in its entirety for all purposes. The combinatorial objective version of computing the ranking function is given by:

rk(a)=arg min a·π,π∈Πₙ (5)

where Πₙ is a set that contains all the permutations of {1, 2, . . . , n}. This reframing enables the leverage of Vlastelica et al. to differentiate through a blackbox combinatorial solver. Vlastelica et al. proposes a family of piecewise affine continuous interpolation functions parameterized by a single hyperparameter that controls the tradeoff between faithfulness to the true function and informativeness of the gradient.

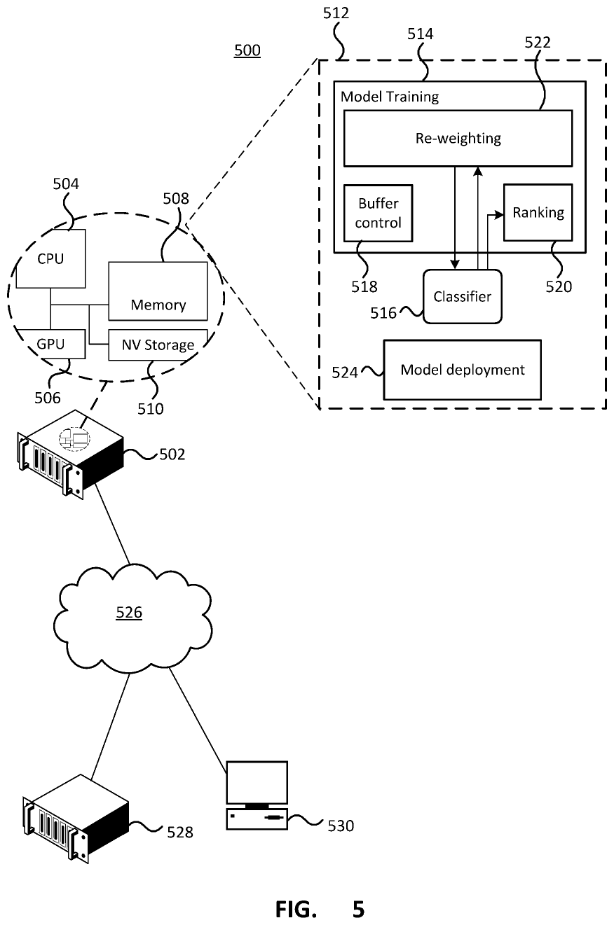

FIG. 5 depicts a system for training and using binary classifier. The system 500 comprises at least one computing device 502 depicted as a server, that can include a processing unit (CPU) 504, a graphic processing unit (GPU) 506, memory 508 and non-volatile storage 510. The memory stores instructions, which when executed by the CPU and/or the GPU configure the system to provide various functionality 512.

The functionality 512 can include model training functionality 514 that can train, and retrain, a classifier model 516 based on batches of input data. The model training functionality 514 may include buffer control functionality 518 that maintains a buffer of a plurality of positive examples from the input batches. The model training can apply the classifier to the input sets, which may include samples from batch input and the buffer. Ranking functionality 520 can generate a ranking from the output scores from the classifier. Re-weighting functionality can adjust the weightings of the classifier based on the classifier output and the ranking provided by the ranking functionality. Once the classifier has been trained to an acceptable or desired level, model deployment functionality may deploy the classifier to one or more systems for use. The trained classifier model may be deployed to the same computing device used for training or to one or more external computing devices 528, 530 that may be in communication with the training computing device 502 via one or more communication networks 526.

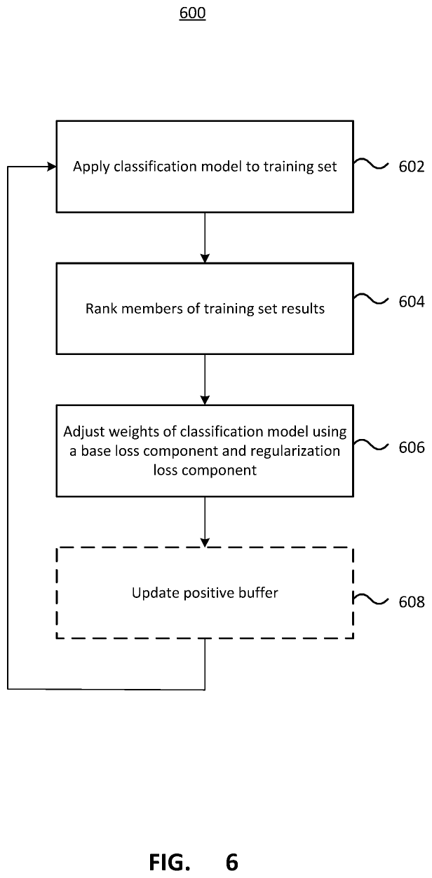

FIG. 6 depicts a method of training a binary classifier. The method 600 includes receiving a training set that includes one or more elements each labelled with one of two possible classification labels. A binary classification model that is being trained is applied to the training set (602) and outputs classification scores for each of the elements in the training set. Members of the training set are then assigned a rank based on the associated classification scores (604). Weights of the classification model are then adjusted using an objective loss function comprising a base objective loss component and a regularization loss component (606). The objective loss function optimizes the classifier based on the scores while the regularization loss component optimizes the classifier based on the ranking. If a buffer is used to maintain a number of positive samples, the buffer can be updated with positive new positive samples from the batch input according to a buffer replacement strategy.

The above has described a ranked-based training of a classifier. The training method was evaluated on a plurality of different datasets as described further below.

The setting of “Constrained optimization to train neural networks on critical and under-represented classes”, of Sangalli et al. in Advances in Neural Information Processing Systems, 2021, which is incorporated herein by reference in its entirety for all purposes, for fair comparison was followed. Experiments were run on all the public datasets used in Sangalli et al. (CIFAR-100 and CIFAR-10), and instead of the in-house medical dataset, another publicly available medical dataset (Melanoma) was used. While CIFAR-100 and CIFAR-10 are sub-sampled into imbalanced binary classification datasets with different imbalance ratios, Melanoma is a naturally imbalanced dataset.

### CIFAR-100

Following Sangalli et al., one super-class is selected as the majority class (aka, negative class) and a sub-class of another super-class is selected as the minority class (aka, the positive class). There are 2250 samples of the majority class and a random number of samples are selected from the minority class to obtain the desired imbalance ratio. For validation, 50 samples from each class were used to tune the hyper-parameters. For testing, 100 samples from each class (all the test images) were used.

### CIFAR-10

Following Sangalli et al., and analogous to CIFAR-100, two random classes were selected for the binary classification task; one of them as the majority and one of them as the minority. All the available training samples of the majority class were used for training while a random number of samples from the minority class were selected to obtain the desired imbalance ratio. For validation, 100 samples from each class are used to tune the hyper-parameters. For testing, 1000 samples from each class (all the test images) are used.

### Melanoma

Melanoma is a skin cancer dataset and experiments were performed the Kaggle Melanoma dataset. The dataset is composed of 33,126 samples where 584 of the images are malignant melanoma, resulting in a 1:176 imbalance ratio. It is split in into training, validation, and test with ratios of 70%, 10%, and 20%, respectively. All images are resized to 256×256.

Different classifier architectures were used in testing the rank-based training. For the CIFAR datasets curated to be imbalanced the ResNet10 architecture was used. For Melanoma which is a much larger dataset the richer architecture of ResNet18 was used.

For CIFAR-10 and CIFAR-100 which are in common with Sangalli et al., the same hyperparameters report for ALM and for all the base loss functions were used. For the Melanoma dataset, Sangalli et al. was followed to tune the hyper-parameters. The more general parameters like learning rate and batch size were chosen and fixed to work with the BCE loss. For ALM of Sangalli et al., a two step grid-search is performed. In the first step, a grid-search was performed over ρ and μ⁽⁰⁾. ρ was chosen from the set {2,3} and μ⁽⁰⁾ from the set {10⁻², 10⁻³, 10⁻⁴, 10⁻⁵, 10⁻⁶, 10⁻⁷, 10⁻⁸, 10⁻⁹} (note that this is a slightly more thorough grid-search than the original paper). When these two are fixed, the best δ, was searched for from the set {0.1,0.25,0.5,1.0}. These parameters are tuned based on the AUC on the validation set.

The proposed regularizer was applied with different existing loss functions, most of which have been designed to handle class imbalance. The base loss functions included classic binary cross-entropy (BCE), symmetric margin loss (S-ML) described by “Large-margin softmax loss for convolutional neural networks,” of Liu et al. in ICML, 2016, the entire contents of which are incorporated herein by reference for all purposes, symmetric focal loss (S-FL) described by “Focal loss for dense object detection,” of Lin et al. in CVPR, 2017, the entire contents of which are incorporated herein by reference for all purposes, asymmetric margin loss (A-ML) and focal loss (A-FL) described by “Over-fitting of neural nets under class imbalance: Analysis and improvements for segmentation,” of Li et al. in MICCAI, 2019, the entire contents of which are incorporated herein by reference for all purposes, cost-weighted BCE (WBCE) described by “Cost-sensitive learning by cost-proportionate example weighting,” of Zadrozny et al. in ICDM, 2003, the entire contents of which are incorporated herein by reference for all purposes, and class-balanced BCE (CB-BCE) described by “Class-balanced loss based on effective number of samples,” of Cui et al. in CVPR, 2019, the entire contents of which are incorporated herein by reference for all purposes, and label distribution aware margin (LDAM) described by “Learning imbalanced datasets with label-distribution-aware margin loss,” of Cao et al. in NeurIPS, 2019, the entire contents of which are incorporated herein by reference for all purposes.

For CIFAR-10 and CIFAR-100 where the datasets are rather small, Sangalli et al. was followed in ensembled models for higher reliability and to diminish dataset-dependent results. For that sake, 10 random stratified splits of the dataset are created and a model is trained on each. Finally, these models are ensembled by averaging their output in the logit space.

The results of classifiers trained using previous training techniques and the ranked-based training techniques as described herein are presented below.

The performance was evaluated using the false positive rate against 4 increasingly strict true positive rates, i.e. FPR@{β} TPR and 3β∈{90%, 92%, 95%, 98%}. For completeness, the performance was also evaluated using area under curve metric (AUC) to reveal the overall classification.

Table 1 compares the performance of using RankReg as well as the previous state-of-the-art method ALM of Sangalli et al. together with eight base losses on CIFAR-10 dataset, curated with a imbalance ratio of 1:100 The empirical results are grouped by base loss (BCE, S-ML, S-FL, etc.). Within each group, the results obtained by applying the base method as well as the previous state-of-the-art approach are first shown. Then, the results of the current approach are shown. For each FPR and overall AUC, the best result is either underlined or highlighted in red text.

It is clear that results of the current approach are consistently better, except for two FPR values at S-FL and A-ML baselines, where RankReg is the second best approach. The performance improvement is especially striking when coupling RankReg with CB-BCE: RangReg reduces the FPR at the strictest TPR ratio by 18%, i.e. from 67.0 to 48.8 in FPR@98% TPR. The best overall results are obtained by fusing the current RankReg with the LDAM baseline, where it achieved the highest AUC score (i.e. 95.0) as well as the lowest FPR@98% TPR value (i.e. 42.8) across all experimental results.

Even though a goal is not to have higher AUC scores, the current approach obtains the new state-of-the-art AUC performance on 7 baselines; ALM of Sangalli et al. leads the score by only 0.3 on W-BCE. These results are believed to be attributable to the immediate enhancement of false positive rates in high true positive requirements.

TABLE 1
Comparison results for binary imbalanced CIFAR-10.

Binary CIFAR10, imb. 1:100

| | FPR@ | FPR@ | FPR@ | |
|---|---|---|---|---|
| Methods | 98% TPR | 95% TPR | 92% TPR | AUC |
| BCE | 56.0 | 45.0 | 29.0 | 91.2 |
| +ALM | 52.0 | 34.0 | 21.0 | 93.1 |
| +RankReg | 47.1 | 26.2 | 20.6 | 94.3 |
| S-ML | 59.0 | 40.0 | 26.0 | 91.7 |
| +ALM | 50.0 | 37.0 | 24.0 | 92.5 |
| +RankReg | 45.6 | 31.4 | 29.7 | 93.9 |
| S-FL | 59.0 | 40.0 | 27.0 | 91.7 |
| +ALM | 55.0 | 39.0 | 25.0 | 91.5 |
| +RankReg | 53.3 | 35.4 | 20.7 | 92.8 |
| A-ML | 54.0 | 36.0 | 23.0 | 92.4 |
| +ALM | 45.0 | 35.0 | 23.0 | 92.8 |
| +RankReg | 47.8 | 28.9 | 21.4 | 94.1 |
| A-FL | 50.0 | 38.0 | 24.0 | 92.3 |
| +ALM | 49.0 | 37.0 | 23.0 | 92.8 |
| +RankReg | 50.5 | 28.7 | 20.9 | 94.3 |
| CB-BCE | 89.0 | 72.0 | 59.0 | 78.0 |
| +ALM | 67.0 | 51.0 | 36.0 | 88.1 |
| +RankReg | 48.8 | 29.9 | 24.6 | 93.2 |
| W-BCE | 69.0 | 52.0 | 37.0 | 87.4 |
| +ALM | 66.0 | 48.0 | 31.0 | 89.3 |
| +RankReg | 60.0 | 39.4 | 29.6 | 92.1 |
| LDAM | 65.0 | 48.0 | 34.0 | 89.0 |
| +ALM | 60.0 | 42.0 | 31.0 | 91.0 |
| +RankReg | 42.8 | 25.6 | 23.8 | 95.0 |

To show the capability of the current method to scale, the method was evaluated on the curated CIFAR-100 dataset. The results in Table 2 are consistent with the results on CIFAR-10. Baseline numbers are quoted from ALM of Sangalli et al. Once again, the current approach is the top performer across most metrics. However, this time, both the BCE and A-ML baselines achieve the highest AUC score using RankReg. Moreover, it is notable that on the highest TPR (i.e. 98%), the current approach outperforms the previous state-of-the-art with the margin >10% on 5 different baselines (i.e. A-FL, S-ML, BCE, LDAM and S-FL). Such notable gains are only observed twice in previous experiments (i.e. LDAM and CB-BCE in Table 1). This might suggest that the current RankReg approach can better contribute on larger datasets.

TABLE 2
Comparison results for binary imbalanced CIFAR-100.

Binary CIFAR100, imb. 1:100

| | FPR@ | FPR@ | FPR@ | |
|---|---|---|---|---|
| Methods | 98% TPR | 95% TPR | 90% TPR | AUC |
| BCE | 93.0 | 63.0 | 47.0 | 81.8 |
| +ALM | 91.0 | 49.0 | 39.0 | 82.7 |
| +RankReg | 85.2 | 42.4 | 28.7 | 85.5 |
| S-ML | 89.0 | 65.0 | 43.0 | 82.7 |
| +ALM | 88.0 | 69.0 | 41.0 | 81.7 |
| +RankReg | 64.0 | 44.8 | 34.5 | 85.4 |
| S-FL | 89.0 | 62.0 | 44.0 | 82.6 |
| +ALM | 88.0 | 60.0 | 42.0 | 81.7 |
| +RankReg | 84.6 | 49.2 | 38.4 | 84.7 |
| A-ML | 91.0 | 63.0 | 44.0 | 81.8 |
| +ALM | 89.0 | 55.0 | 37.0 | 82.7 |
| +RankReg | 81.6 | 43.4 | 32.6 | 85.5 |
| A-FL | 88.0 | 63.0 | 45.0 | 82.8 |
| +ALM | 86.0 | 62.0 | 40.0 | 83.2 |
| +RankReg | 70.0 | 53.4 | 35.8 | 84.6 |
| CB-BCE | 93.0 | 75.0 | 52.0 | 78.8 |
| +ALM | 89.0 | 59.0 | 36.0 | 83.8 |
| +RankReg | 89.8 | 48.6 | 33.4 | 84.1 |
| W-BCE | 88.0 | 59.0 | 41.0 | 79.7 |
| +ALM | 87.0 | 53.0 | 39.0 | 83.2 |
| +RankReg | 84.0 | 60.0 | 41.1 | 82.9 |
| LDAM | 84.0 | 70.0 | 42.0 | 82.3 |
| +ALM | 80.0 | 59.0 | 40.0 | 83.2 |
| +RankReg | 70.3 | 51.6 | 35.0 | 84.7 |

The RankReg approach is demonstrated on imbalanced cancer classification using the Melanoma benchmark and the results shown in Table 3. It is believed that this is the first comparison study of FPR vs. TPR on such a large-scale dataset, and as such there is a lack of comparison methods. Therefore, the results are provided for all baselines as well as their combination with ALM by running experiments. It can be seen that, across all baselines, RankReg achieves state-of-the-art performance in the majority of metrics, with a minor setback on LDAM, where both the current approach and ALM achieve one best metric.

TABLE 3
Comparison results for Melanoma dataset.

| | Melanoma, imb. 1:170 | | | | |
|---|---|---|---|---|---|
| | FPR@ | FPR@ | FPR@ | FPR@ | |
| Methods | 98% TPR | 95% TPR | 92% TPR | 90% TPR | AUC |
| BCE | 49.8 | 45.9 | 38.6 | 35.5 | 85.7 |
| +ALM | 49.9 | 41.8 | 40.0 | 37.7 | 85.6 |
| +RankReg | 49.4 | 37.9 | 33.9 | 31.6 | 86.8 |
| S-ML | 46.6 | 42.8 | 38.4 | 37.4 | 85.3 |
| +ALM | 51.3 | 40.5 | 39.8 | 36.2 | 83.5 |
| +RankReg | 54.6 | 42.4 | 36.1 | 34.4 | 86.3 |
| S-FL | 59.0 | 47.3 | 44.4 | 39.5 | 83.8 |
| +ALM | 47.8 | 42.7 | 39.2 | 38.1 | 84.0 |
| +RankReg | 56.6 | 37.8 | 31.2 | 29.8 | 86.1 |
| A-ML | 47.5 | 42.9 | 40.4 | 36.6 | 85.4 |
| +ALM | 51.0 | 41.5 | 37.5 | 37.1 | 83.7 |
| +RankReg | 58.3 | 40.8 | 36.7 | 33.9 | 86.2 |
| A-FL | 55.6 | 45.0 | 42.7 | 41.2 | 84.4 |
| +ALM | 49.0 | 42.4 | 40.1 | 38.1 | 83.6 |
| +RankReg | 48.0 | 36.2 | 30.7 | 28.8 | 86.3 |
| CB-BCE | 67.2 | 59.5 | 35.7 | 33.2 | 82.6 |
| +ALM | 60.8 | 59.5 | 46.3 | 45.8 | 81.5 |
| +RankReg | 57.8 | 44.9 | 35.7 | 34.7 | 83.7 |
| W-BCE | 69.0 | 52.0 | 37.0 | 32.1 | 87.4 |
| +ALM | 66.0 | 48.0 | 31.0 | 30.7 | 89.3 |
| +RankReg | 56.4 | 41.1 | 33.0 | 30.5 | 90.9 |
| LDAM | 59.7 | 48.2 | 46.2 | 39.0 | 83.4 |
| +ALM | 62.7 | 47.7 | 43.3 | 70.7 | 81.5 |
| +RankReg | 65.6 | 47.5 | 45.7 | 43.9 | 81.7 |

A number of ablation studies were performed to evaluate various different options on the training as described further below.

The current RankReg approach uses a buffer of critical positive samples to have meaningful ranking regularization signals at each batch of training. An ablation study was performed to evaluate the role of buffer by considering three kinds of maintenance strategies: (1) remove the most confident sample while adding new positive samples from an incoming batch (ie, Dequeue Max), (2) first-in-first-out (ie, FIFO), and (3) remove the least confident sample (ie, Dequeue Min), and (3) randomly selecting positive samples. The results in Table 4 show that feeding sufficient amount of low-ranking positives to the model is useful, as evidenced by the increased performance across all metrics. Swapping out the most confident sample with incoming ones (i.e. Dequeue Max) performs better than first-in-first-out.

TABLE 4
Ablation study on buffer update strategy.

| | CIFAR100 | | | | Melanoma | | | |
|---|---|---|---|---|---|---|---|---|
| FPR@βTPR | 98% | 95% | 92% | AUC | 98% | 95% | 92% | AUC |
| Dequeue Max | 85.2 | 42.4 | 28.7 | 85.5 | 49.4 | 37.9 | 33.9 | 86.8 |
| FIFO | 86.8 | 44.2 | 31.2 | 85.2 | 59.2 | 47.6 | 40.5 | 83.1 |
| Dequeue Min | 88.2 | 55.9 | 44.8 | 83.2 | | | | |

Throughout the empirical results above, a buffer size of 32 was used to be comparable with other methods. Table 5 shows that the buffer plays an important role in the current approach. Indeed, excluding the buffer component yields worse results; and performance, especially for FPR@98TPR, improves quickly as buffer size increases. 32 appears to be an improving plateau.

TABLE 5
False positive rate results at high true
positive rates for various buffer sizes.

| | CIFAR10 | | | | CIFAR100 | | | |
|---|---|---|---|---|---|---|---|---|
| FPR@βTPR | 98% | 95% | 92% | AUC | 98% | 95% | 90% | AUC |
| Buffer = 0 | 58.8 | 43.6 | 30.2 | 90.4 | 93.4 | 48.4 | 37.4 | 83.1 |
| Buffer = 5 | 53.0 | 42.4 | 28.7 | 92.6 | 86.6 | 57.2 | 39.0 | 82.5 |
| Buffer = 10 | 48.1 | 26.9 | 26.2 | 94.5 | 85.2 | 50.2 | 28.7 | 84.6 |
| Buffer = 20 | 47.6 | 26.2 | 22.0 | 93.8 | 85.2 | 50.0 | 29.8 | 84.9 |
| Buffer = 32 | 47.1 | 26.2 | 20.6 | 94.3 | 83.0 | 42.4 | 31.4 | 85.5 |
| Buffer = 48 | 46.1 | 24.3 | 23.2 | 93.9 | 85.2 | 42.1 | 27.6 | 85.5 |

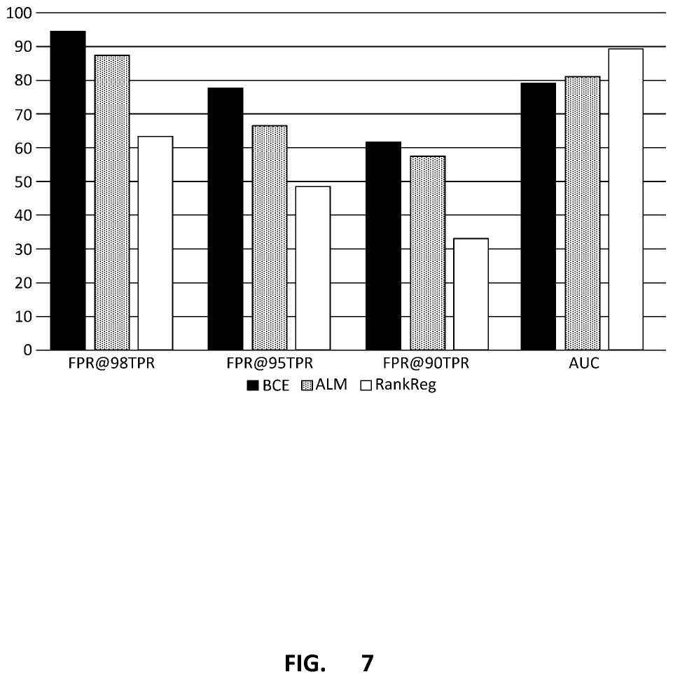

The RankReg model was also tested on more imbalanced situations, e.g. 1:200 imbalance ratio. To this end, the same data curation pipeline as described above was used to build binary imbalanced CIFAR-10 and 100 datasets with a 1:200 imbalance ratio. The results of ranking regularizer coupled with the BCE baseline is shown in FIG. 7. It is seen that the current approach brings in clear benefits.

Table 6 shows an ablation study on different choices for the rank penalty in Eq. 4 including raw rank values, squared rank values, cubed rank values, and the exponential of rank values. Squared rank provides the best overall result while being simple.

TABLE 6
Ablation study of different ranking penalty choices.

| | CIFAR10 | | | | CIFAR100 | | | |
|---|---|---|---|---|---|---|---|---|
| FPR@βTPR | 98% | 95% | 92% | AUC | 98% | 95% | 90% | AUC |
| Ranks | 52.1 | 35.2 | 24.0 | 93.6 | 86.3 | 52.8 | 43.0 | 83.2 |
| Squared ranks | 47.1 | 26.2 | 20.6 | 94.3 | 85.2 | 42.4 | 28.7 | 85.5 |
| Cubed ranks | 45.5 | 31.9 | 23.0 | 93.7 | 84.2 | 53.8 | 50.4 | 83.7 |
| Exponential of | 44.5 | 34.0 | 24.3 | 93.6 | 83.6 | 48.8 | 39.4 | 84.9 |
| ranks | | | | | | | | |

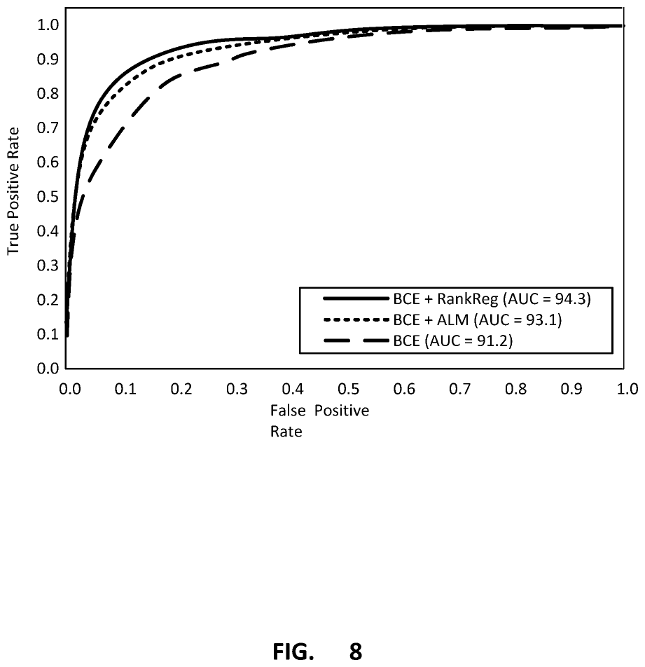

FIG. 8 depicts graphs of false positive rates vs. true positive rates for different methods. To further estimate the effectiveness of the current approach to reduce false positive rates at high true positive rates, the ROC curves of the current approach as well as comparison methods are visualized, as shown in FIG. 8. The top two curves (ie, The current approach and ALM) significantly surpass that of the BCE baseline on FPRs at earlier TPRs, ie, starting from 30% TPR and onward. Importantly, the current approach performs on par with ALM up until ˜75% TPR, and then consistently yields lower FPR values ever since to almost 100% TPR.

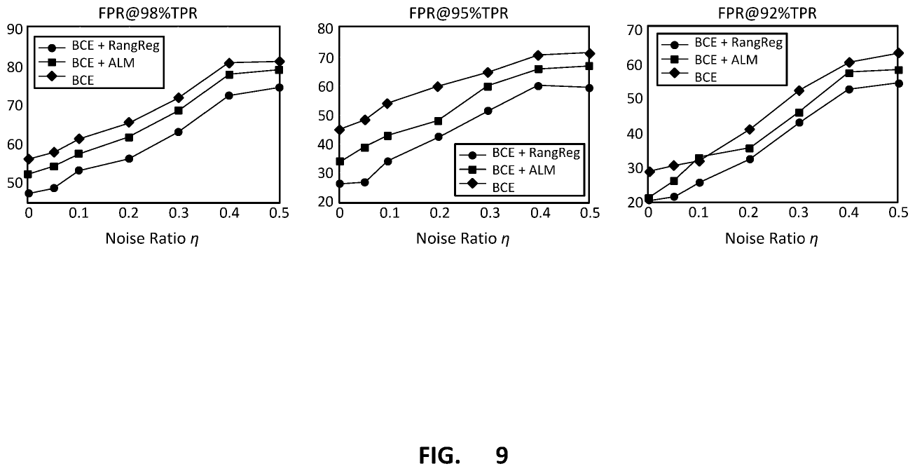

FIG. 9 depicts noise ratio graphs for FPR@ different TPR. Real-world datasets often contain mislabeled data. To evaluate the robustness of the current approach in the presence of label noise, additional experiments were performed in which a proportion of training labels were incrementally flipped. FIG. 9 shows how FPR at (98, 95, 92)% TPR (left to right) degrade as a function of proportion in the range of [0, 0.5] using BCE as base loss. These results suggest that RankReg is as robust to label noise as the state-of-the-art approach.

RankReg can be used in multi-class settings by ranking the critical samples higher than others based on the output probability for each class. Table 7 shows additional results in the multi-class setting using long-tailed CIFAR-10 following the experiment protocol in ALM. The average error rate of other classes after setting thresholds for (80, 90)% TPR on the critical class is reported. The current method performs better than ALM under the 1:100 imbalance ratio setting and comparably under the 1:200 setting.

TABLE 7
Results of Multi-class experiments using long-tailed CIFAR-10

| | LT-CIFAR10 imb. 100 | | | LT-CIFAR10 imb. 200 | | |
|---|---|---|---|---|---|---|
| Error@β% TPR | 80% | 90% | Acc. | 80% | 90% | Acc |
| CE | 29.8 | 34.7 | 70.4 | 37.8 | 42.4 | 64.0 |
| CE + ALM | 28.9 | 33.9 | 70.9 | 36.1 | 39.9 | 65.1 |
| CE + RankReg | 26.7 | 29.3 | 71.6 | 36.7 | 37.8 | 65.0 |

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method of training a binary classifier comprising:
applying a binary classification model to a training set to generate a classification score for each member of the set, the training set including true classification labels for each member;
ranking the members of the training set based on the classification scores; and
adjusting weights of the binary classification model using a loss function comprising:
a base objective loss component based on classification scores of the training set; and
a regularization loss component based on the ranking of members of the training set with a positive true classification label.

2. The method of claim 1, wherein ranking the members is given by:
r=rk([f_{θ}(x₁),f_{θ}(x₂), . . . ,f_{θ}(x_{B})],
where:
rk(a)=arg min a·π,π∈Πₙ
and where Πₙ is a set that contains all the permutations of {1, 2, . . . , n}.

3. The method of claim 1, wherein the regularization loss component is given by:
$${ℓ}_{reg} ( {f}_{θ} ( x ) , y ) = \frac{1}{\vert P \vert} {\sum }_{i = 1}^{B} {r}_{i}^{2} \cdot II [ {y}_{i} = 1 ] ,$$
where [symbol] [] is the indicator function.

4. The method of claim 1, wherein the base objective function comprises one or more of:
classic binary cross-entropy (BCE);
symmetric margin loss (S-ML);
symmetric focal loss (S-FL);
asymmetric margin loss (A-ML);
asymmetric focal loss (A-FL);
cost-weighted BCE (WBCE);
class-balanced BCE (CB-BCE); and
label distribution aware margin (LDAM).

5. The method of claim 1, wherein the loss function is given by: [symbol]
(f_{θ}(x),y)= [symbol] _{base}(x),y)+λ [symbol] _{reg}(f_{θ}(x),y),
where [symbol] _{base} is the base objective loss component; [symbol]
_{reg} is the ranked-based regularization component; and
λ is a balancing hyperparameter.

6. The method of claim 1, wherein the training set comprises:
a plurality of batch training samples; and
a plurality of positive class samples stored in a positive class buffer.

7. The method of claim 1, wherein positive class samples from the batch training samples are used to updated the positive class buffer.

8. The method of claim 1, where the positive class buffer is updated according to one or more of:
a first in first out policy; and
a deMax policy.

9. The method of claim 1, further comprising deploying the trained classification model to one or more computing systems.

10. The method of claim 9 further comprising:
receiving an unknown sample of data; and
classifying the unknown sample as either being in the positive class or the negative class using the deployed trained classifier.

11. A non-transitory computer readable medium having stored thereon instruction which when executed configure a computing device to perform a method comprising:
applying a binary classification model to a training set to generate a classification score for each member of the set, the training set including true classification labels for each member;
ranking the members of the training set based on the classification scores; and
adjusting weights of the binary classification model using a loss function comprising:
a base objective loss component based on classification scores of the training set; and
a regularization loss component based on the ranking of members of the training set with a positive true classification label.

12. The method of claim 1, wherein ranking the members is given by:
r=rk([f_{θ}(x₁),f_{θ}(x₂), . . . ,f_{θ}(x_{B})],
where:
rk(a)=arg min a·π,π∈Πₙ
and where Πₙ is a set that contains all the permutations of {1, 2, . . . , n}.

13. The method of claim 1, wherein the regularization loss component is given by:
$${ℓ}_{reg} ( {f}_{θ} ( x ) , y ) = \frac{1}{\vert P \vert} {\sum }_{i = 1}^{B} {r}_{i}^{2} \cdot II [ {y}_{i} = 1 ] ,$$
where [symbol] [] is the indicator function.

14. The method of claim 1, wherein the base objective function comprises one or more of:
classic binary cross-entropy (BCE);
symmetric margin loss (S-ML);
symmetric focal loss (S-FL);
asymmetric margin loss (A-ML);
asymmetric focal loss (A-FL);
cost-weighted BCE (WBCE);
class-balanced BCE (CB-BCE); and
label distribution aware margin (LDAM).

15. The method of claim 1, wherein the loss function is given by: [symbol]
(f_{θ}(x),y)= [symbol] _{base}(f_{θ}(x),y)+λ [symbol] _{reg}(f_{θ}(x),y),
where [symbol] _{base} the base objective loss component; [symbol]
_{reg} is the ranked-based regularization component; and
λ is a balancing hyperparameter.

16. The method of claim 1, wherein the training set comprises:
a plurality of batch training samples; and
a plurality of positive class samples stored in a positive class buffer.

17. The method of claim 1, wherein positive class samples from the batch training samples are used to updated the positive class buffer.

18. The method of claim 1, where the positive class buffer is updated according to one or more of:
a first in first out policy; and
a deMax policy.

19. The method of claim 1, further comprising deploying the trained classification model to one or more computing systems.

20. The method of claim 9 further comprising:
receiving an unknown sample of data; and
classifying the unknown sample as either being in the positive class or the negative class using the deployed trained classifier.

21. A computing system comprising:
a processor for executing instructions; and
a memory storing instruction which when executed by the processor configure the computing device to perform a method comprising:
applying a binary classification model to a training set to generate a classification score for each member of the set, the training set including true classification labels for each member;
ranking the members of the training set based on the classification scores; and
adjusting weights of the binary classification model using a loss function comprising:
a base objective loss component based on classification scores of the training set; and
a regularization loss component based on the ranking of members of the training set with a positive true classification label.
